(19) United States
(12) Patent Application Publication
(10) Pub. No.: US 2020/0269753 A1
(43) Pub. Date: Aug. 27, 2020

(54) Vehicle Hazard Alert Assembly

(71) Applicant: Dee Meas, Buena Park, CA (US)

(72) Inventor: Dee Meas, Buena Park, CA (US)

(21) Appl. No.: 16/281,161

(22) Filed: Feb. 21, 2019

(51) Int. Cl. B60Q 1/52; B60Q 1/00

(52) U.S. Cl. CPC B60Q 1/525; B60Q 1/0076; B60Q 1/0094

(57) ABSTRACT

A vehicle hazard alert assembly for increasing safety during an automobile accident includes a plug is electrically coupled to an OBD-II port in a vehicle. A motion sensing unit is electrically coupled to the plug and the motions sensing unit includes an accelerometer. Thus, the motion sensing unit can sense acceleration and deceleration of the vehicle. Moreover, the motion sensing unit communicates an alert signal to the plug when the motion sensing unit senses motion of the vehicle that is consistent with collision avoidance maneuvers. The plug communicates the alert signal to the computer module thereby facilitating the computer module to turn on the hazard lights of the vehicle. In this way the motion sensing unit alerts oncoming motorists of a potential collision hazard.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to alert devices and more particularly pertains to a new alert device for increasing safety during an automobile accident.

### BRIEF SUMMARY OF THE INVENTION

An embodiment of the disclosure meets the needs presented above by generally comprising a plug is electrically coupled to an OBD-II port in a vehicle. A motion sensing unit is electrically coupled to the plug and the motions sensing unit includes an accelerometer. Thus, the motion sensing unit can sense acceleration and deceleration of the vehicle. Moreover, the motion sensing unit communicates an alert signal to the plug when the motion sensing unit senses motion of the vehicle that is consistent with collision avoidance maneuvers. The plug communicates the alert signal to the computer module thereby facilitating the computer module to turn on the hazard lights of the vehicle. In this way the motion sensing unit alerts oncoming motorists of a potential collision hazard.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a vehicle hazard alert assembly according to an embodiment of the disclosure.

FIG. 2 is a front view of an embodiment of the disclosure.

FIG. 3 is a bottom view of an embodiment of the disclosure.

FIG. 4 is a schematic view of an embodiment of the disclosure.

FIG. 5 is an interior view of vehicle of an embodiment of the disclosure.

FIG. 6 is a perspective in-use view of an embodiment of the disclosure.

### DETAILED DESCRIPTION OF THE INVENTION

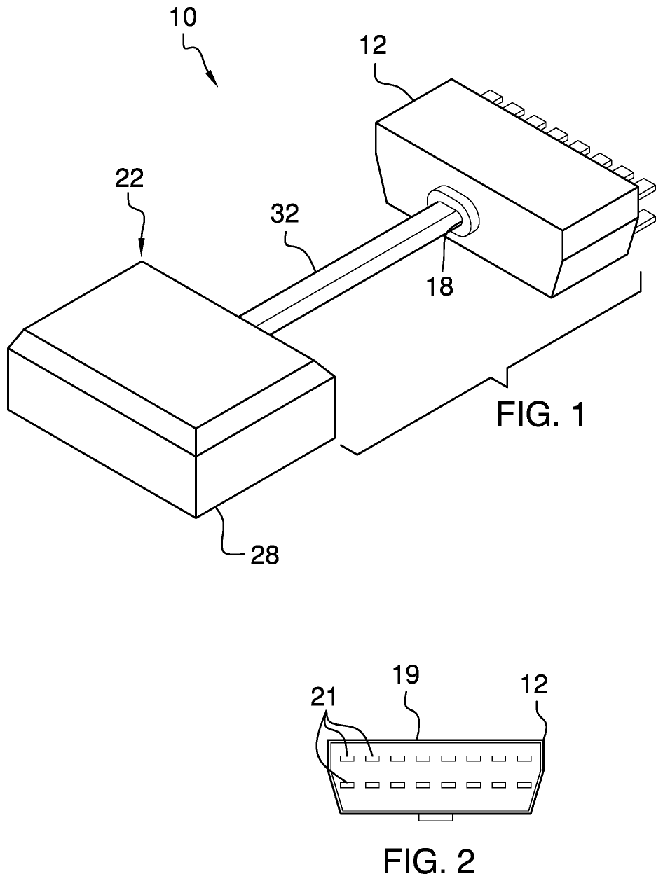

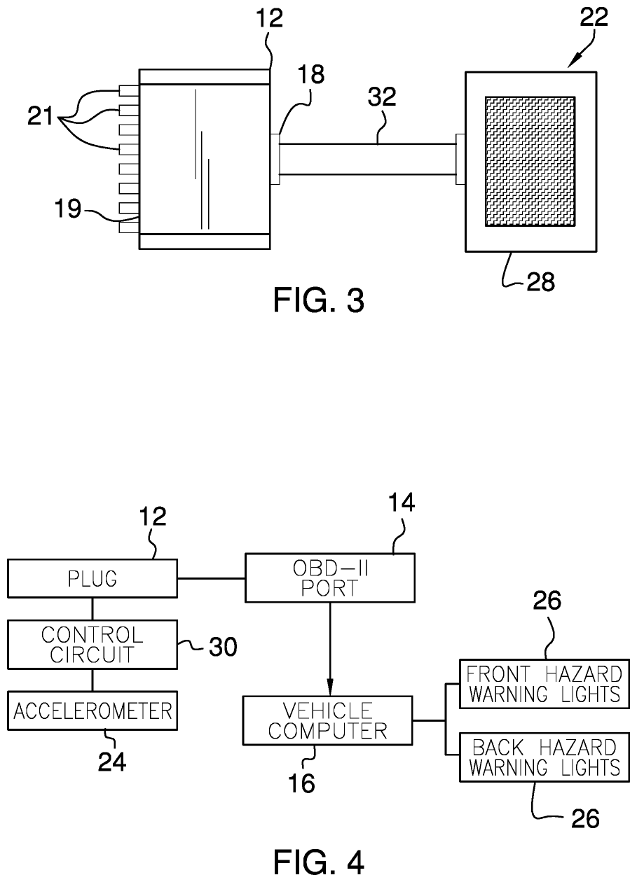

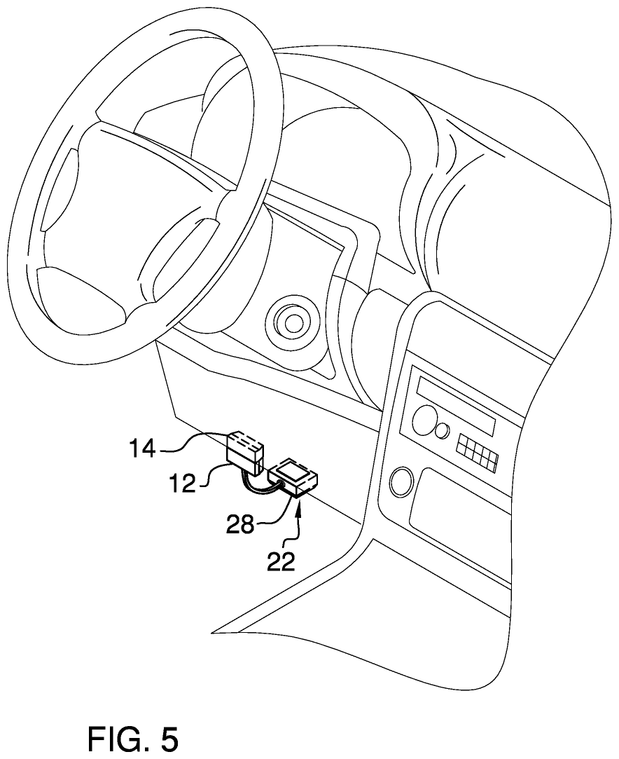

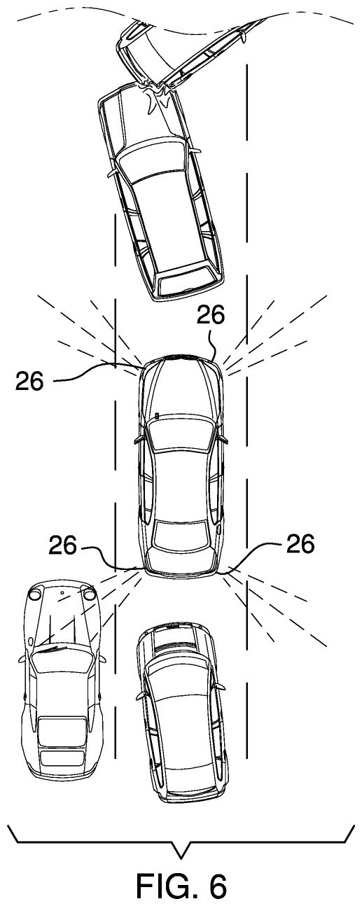

With reference now to the drawings, and in particular to FIGS. 1 through 6 thereof, a new alert device embodying the principles and concepts of an embodiment of the disclosure and generally designated by the reference numeral 10 will be described.

As best illustrated in FIGS. 1 through 6, the vehicle hazard alert assembly 10 generally comprises a plug 12 is electrically coupled to an OBD-II port 14 in a vehicle. In this way the plug 12 is placed in electrical communication with a computer module 16 in the vehicle. The vehicle may be a passenger vehicle manufactured after 1994. The plug 12 has an output 18 and the plug 12 is in electrical communication a power source 20 comprising the vehicle's electrical system. The plug 12 has a distal edge 19 that is shaped to fit the particular shape of the OBD-II port 14 and the plug 12 includes a plurality of terminals 21 that fit the OBD-II port 14.

A motion sensing unit 22 is electrically coupled to the plug 12 and the motions sensing unit includes an accelerometer 24. In this way the motion sensing can sense acceleration and deceleration of the vehicle. Moreover, the motion sensing unit 22 communicates an alert signal to the plug 12 when the motion sensing unit 22 senses motion of the vehicle that is consistent with collision avoidance maneuvers, such as hard braking, swerving and other similar maneuvers. The plug 12 communicates the alert signal to the computer module 16 thereby facilitating the computer module 16 to turn on the hazard lights 26 of the vehicle. In this way the motion sensing unit 22 can alert oncoming motorists of a potential collision hazard.

The motion sensing unit 22 comprises a housing 28 that is coupled to the vehicle and the housing 28 may be positioned beneath the dashboard or at some other inconspicuous location within the vehicle. A control circuit 30 is positioned within the housing 28 and the control circuit 30 receives an alert input and a cease input. Additionally, the control circuit 30 is in communication with a speedometer circuit of the vehicle. The motion sensing unit 22 may include a gyroscope and any other electronic devices used to detect parameters of motion in three dimensions.

A conductor 32 is coupled between the housing 28 the output 18 of the plug 12, and the conductor 32 is electrically coupled to the output 18 and the control circuit 30. The conductor 32 communicates the alert input to the plug 12 and the plug 12 communicates the alert input to the computer module 16 in the vehicle for turning on the vehicle's hazard lights 26. In this way the vehicle's hazard lights 26 are turned on when the vehicle make maneuvers consistent with collision avoidance. Thus, oncoming motorists are immediately notified of a potential hazard and can have the maximum amount of reaction time available to them.

The accelerometer 24 is positioned within the housing 28 and the accelerometer 24 is electrically coupled to the control circuit 30. The control circuit 30 receives the alert input when the accelerometer 24 detects acceleration or deceleration forces that exceed a predetermined trigger amount of force. Additionally, the control circuit 30 receives the cease input when the speedometer circuit senses the vehicle has exceeded a trigger velocity. Thus, the conductor 32 communicates the cease input to the plug 12 and the plug 12 communicates the cease input to the computer module 16 in the vehicle for turning off the vehicle's hazard lights 26.

In use, the plug 12 is plugged into the OBD-II port 14 in the vehicle and the housing 28 his coupled to the vehicle with hook and loop fasteners, adhesive tape or any other preferred means. The control circuit 30 receives the alert input when the accelerometer 24 senses that the vehicle is making maneuvers consistent with collision avoidance. Thus, the computer module 16 in the vehicle turns on the vehicle's hazard lights 26. In this way oncoming motorists are immediately notified of a potential hazard and can react accordingly. The control circuit 30 receives the cease input when the vehicle has accelerated beyond the trigger velocity and the hazard lights 26 are turned off.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A vehicle hazard alert assembly being configured to turn on hazard lights on a vehicle when the vehicle makes maneuvers consistent with collision avoidance, said assembly comprising:
a plug being electrically coupled to an OBD-II port in a vehicle wherein said plug is configured to be in electrical communication with a computer module in the vehicle; and
a motion sensing unit being electrically coupled to said plug, said motions sensing unit including an accelerometer wherein said motion sensing unit is configured to sense acceleration and deceleration of the vehicle, said motion sensing unit communicating an alert signal to said plug when said motion sensing unit senses motion of the vehicle that is consistent with collision avoidance maneuvers, said plug communicating said alert signal to the computer module thereby facilitating the computer module to turn on the hazard lights of the vehicle wherein said motion sensing unit is configured to alert oncoming motorists of a potential collision hazard.

2. The assembly according to claim 1, wherein said plug has an output, said plug being in electrical communication a power source comprising the vehicle's electrical system.

3. The assembly according to claim 2, wherein said motions sensing unit comprises:
a housing being coupled to the vehicle;
a control circuit being positioned within said housing, said control circuit receiving an alert input and a cease input, said control circuit being in communication with a speedometer circuit of the vehicle; and
a conductor being coupled between said housing said output of said plug, said conductor being electrically coupled to said output and said control circuit, said conductor communicating said alert input to said plug, said plug communicating said alert input to the computer module in the vehicle for turning on the vehicle's hazard lights.

4. The assembly according to claim 3, wherein said accelerometer is positioned within said housing, said accelerometer being electrically coupled to said control circuit, said control circuit receiving said alert input when said accelerometer detects acceleration or deceleration forces that exceed a predetermined trigger amount of force.

5. The assembly according to claim 3, wherein said control circuit receives said cease input when said speedometer circuit senses the vehicle has exceeded a trigger velocity, said conductor communicating said cease input to said plug, said plug communicating said cease input to the computer module in the vehicle for turning off the vehicle's hazard lights.

6. A vehicle hazard alert assembly being configured to turn on hazard lights on a vehicle when the vehicle makes maneuvers consistent with collision avoidance, said assembly comprising:
a plug being electrically coupled to an OBD-II port in a vehicle wherein said plug is configured to be in electrical communication with a computer module in the vehicle, said plug having an output, said plug being in electrical communication a power source comprising the vehicle's electrical system;
a motion sensing unit being electrically coupled to said plug, said motions sensing unit including an accelerometer wherein said motion sensing unit is configured to sense acceleration and deceleration of the vehicle, said motion sensing unit communicating an alert signal to said plug when said motion sensing unit senses motion of the vehicle that is consistent with collision avoidance maneuvers, said plug communicating said alert signal to the computer module thereby facilitating the computer module to turn on the hazard lights of the vehicle wherein said motion sensing unit is configured to alert oncoming motorists of a potential collision hazard, said motions sensing unit comprising:
a housing being coupled to the vehicle;
a control circuit being positioned within said housing, said control circuit receiving an alert input and a cease input, said control circuit being in communication with a speedometer circuit of the vehicle;
a conductor being coupled between said housing said output of said plug, said conductor being electrically coupled to said output and said control circuit, said conductor communicating said alert input to said plug, said plug communicating said alert input to the computer module in the vehicle for turning on the vehicle's hazard lights;
said accelerometer being positioned within said housing, said accelerometer being electrically coupled to said control circuit, said control circuit receiving said alert input when said accelerometer detects acceleration or deceleration forces that exceed a predetermined trigger amount of force, said control circuit receiving said cease input when said speedometer circuit senses the vehicle has exceeded a trigger velocity, said conductor communicating said cease input to said plug, said plug communicating said cease input to the computer module in the vehicle for turning off the vehicle's hazard lights.
